(19) United States
(12) Patent Application Publication
(10) Pub. No.: US 2006/0126073 A1
(43) Pub. Date: Jun. 15, 2006

(54) Displacement measuring interferometer system and method using tunable lasers

(75) Inventors: Thomas Farrell, Dublin (IE); David McDonald, Dublin (IE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Intune Technologies Limited

(21) Appl. No.: 11/298,068

(22) Filed: Dec. 9, 2005

(30) Foreign Application Priority Data
Dec. 9, 2004 (IE) S2004/0828

(51) Int. Cl. G01B 9/02

(52) U.S. Cl. 356/482

(57) ABSTRACT

A displacement measuring interferometer system and method for measuring the distance between two known points is disclosed. An interferometer is configured to provide a reference reflection of a reference point and a measurement reflection of a measurement point. A tunable laser is used to scan in wavelength into the interferometer to detect interferometer characteristics to measure the distance between the reference point and the measurement point from the interferometer characteristics. The invention describes a displacement measuring interferometer which uses a scanning tunable laser to accurately map out a fringe such that significant improvement in accuracy can be achieved by use of a tunable laser to scan the wavelengths and determine the fringe.

### FIELD

The invention relates to a displacement measuring interferometer system and method using a tunable laser that enables high accuracy, high measurement speed and ease of optics through a fibre optic delivery method.

### BACKGROUND

Typically laser systems that have been employed for displacement measuring interferometers use single frequency laser sources in either a homodyne (Single wavelength) or heterodyne methods (dual wavelength). Heterodyne is normally implemented by use of the Zeeman technique or use of an acousto-optic frequency shifter often implemented using a Bragg Cell. By means of an interferometer the light signal on a receiver is comprised of a reference beam and a measurement beam where destructive or constructive interference occurs depending on the phase difference between the two incident light beams. The change between constructive and destructive interference can be seen as high and low levels of current from a photodiode. This current will change from a high to a low level as the phase difference between the two signals changes by half of a wavelength of the light. By measuring this effect the distance between the two path lengths of the interferometer can be measured to scales less than a wavelength of light.

Multi section laser diodes are known in the art and can be swept between different wavelengths. Typically, the diode is calibrated at manufacture to determine the correct controls that should be applied so as to effect the desired output frequencies from the laser. One of the first known multi-section laser diodes is a three-section tuneable distributed Bragg reflector (DBR) laser. Other types of multi-section diode lasers are the sampled grating DBR (SG-DBR), the superstructure sampled DBR (SSG-DBR) and the grating assisted coupler with rear sampled or superstructure grating reflector (GCSR). There are also other laser types such as the External Cavity Laser (ECL) and gas lasers. A review of such lasers is given in Jens Buus, Markus Christian Amann, “Tuneable Laser Diodes” Artect House, 1998 and “Widely Tuneable Semiconductor Lasers” ECOC'00. Beck Mason.

Current displacement measurement interferometers suffer form several drawbacks in their measurement accuracy capability. Homodyne based instruments suffer from sensitivity to the intensity of the laser radiation, ambient light and are not “always measuring”. Systems based on the heterodyne principle alleviate many of the homodyne related problems but suffers itself from requiring high bandwidth receiving electronics, which ultimately limits the displacement resolution possible. There is a need to provide a system and method to overcome these problems

The object of the present invention is to provide a system and method to measure displacement of an object by means of a tunable laser based interferometer system to overcome the above mentioned drawbacks.

### SUMMARY

The present invention provides a system and method, as set out in the appended claims, of implementing a displacement measuring interferometer using a tunable laser that provides precise measurement of displacement by scanning the laser over a wide wavelength range.

According to one embodiment of the present invention there is provided a displacement measuring interferometer system for measuring the distance between two known points comprising an interferometer configured to provide a reference reflection of a reference point and a measurement reflection of a measurement point; and a tunable laser configured to scan in wavelength into the interferometer to detect interferometer characteristics to measure the distance between said reference point and said measurement point from said interferometer characteristics.

The present invention describes a displacement measuring interferometer which uses a scanning tunable laser to accurately map out a fringe and hence the phase difference between the two arms of the interferometer. The invention provides a method such that significant improvement in accuracy can be achieved by use of a tunable laser to scan the wavelengths and determine the fringe. Also this invention provides a fibre optic light delivery system that is easy to implement and provides advantages when coupled with this solution. The displacement interferometer system of the present invention based on tunable lasers supports the characteristics of the heterodyne based systems but overcomes the other system problems through a combination of choice of the interferometer free spectral range and the tuning range of the laser, both of which can be configured.

Ideally, the interferometer can be configured by means of a fibre tip wherein a reference reflection is obtained from the glass to air interface at the tip of the fibre and a measurement reflection is obtained from a reflection of the transmitted light from the fibre tip to the measurement surface or point and back into the fibre tip.

Suitably, the tunable laser is configured to scan over a wavelength range of at least one fringe of the interferometer.

In one embodiment a reference point such as a gas cell, fibre bragg grating, fabry perot etalon, is used to reference the wavelength scan of the tunable laser.

Desirably, the wavelength of a fringe of the interferometer is determined from a time and wavelength measurement of the tunable laser. A digital counter maybe used which is used to increment or decrement when a fringe moves out of range of the wavelength range of the tunable laser and another one is measured.

An additional tunable laser maybe provided and used to monitor a fringe and increment or decrement the digital counter. Ideally, the measured wavelength of a fringe is used to calculate the distance between the fibre tip and the measurement point. The tunable laser performs the measurement at high sample rates. Averaging and/or filtering is performed on data to improve the accuracy of the system.

The measurement fibre can be anti-reflection coated and a second optical path used for the reference beam.

In another embodiment of the present invention there is provided a method of measuring the distance between two known points in a displacement measuring interferometer system comprising the steps of:
configuring an interferometer to provide a reference reflection of a reference point and a measurement reflection of a measurement point;
scanning in wavelength into the interferometer from a tunable laser to detect interferometer characteristics; and
measuring the distance between said reference point and said measurement point from said interferometer characteristics.

There is also provided a computer program comprising program instructions for causing a computer program to carry out the above method which may be embodied on a record medium, carrier signal or read-only memory.

### BRIEF DESCRIPTION OF THE DRAWINGS

These and other features of the present invention will better understood with reference to the following drawings wherein:

FIG. 1 shows an embodiment of the invention.

FIG. 2 shows an optical fibre tip and mirror configuration according to one aspect of the invention.

FIG. 3 shows two measurements of the tunable laser where the path difference in the interferometer is different.

FIG. 4 shows the resultant peak detection where the distance between the fibre tip and mirror is changed linearly over a few micrometers.

FIG. 5 shows the calculated displacement distance from processing the measurement shown in FIG. 4.

FIG. 6 shows another embodiment of the invention where an additional laser is used to monitor the peaks and update the digital counter.

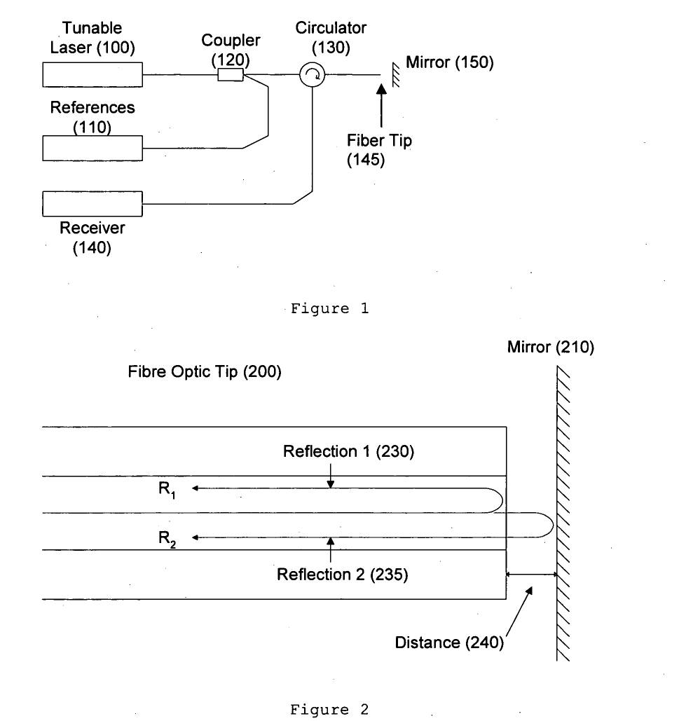

### DETAILED DESCRIPTION

The invention will now be described with reference to exemplary embodiments thereof and it will be appreciated that it is not intended to limit the application or methodology to any specific example. It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Referring initially to FIG. I shows an embodiment of the measurement system where a tunable laser (100) is swept over a wavelength range. Part of the output of the laser is coupled to wavelength references (110) by means of an optical coupler (120). A circulator (130) is used to transmit the light signal to the fibre tip and mirror (150) and pass the reflected signal to a receiver (140). In an embodiment of the invention the interferometer system is created by two light paths of different wavelength arriving at the receiver (140). The first light path is from the tunable laser (100), through the coupler (120) and circulator (130), reflected from the glass to air transition at the fibre tip (145) and back into the circulator (130) which is then output to the receiver (140). The second light path is the same except the remaining light that is not reflected at the fibre tip is reflected off the mirror (150) and back into the fibre tip. The difference in the light paths is twice the distance from the fibre tip to the mirror. The typical reflection from the fibre tip is about 4% of the incident light while the mirror reflection will depend on the numerical aperture of the fibre, the quality of the mirror and the distance from mirror to fibre tip. The fibre tip provides a reference point and the measurement point is a point on the surface of the mirror.

The tunable laser is configured so that it performs a wavelength sweep over a predetermined wavelength range. The wavelength references sample a portion of the output light of the laser and perform an accurate wavelength calibration of each sweep of the laser. The receiver samples the reflected signal from the fibre tip and mirror. By processing the receiver signal in conjunction with the wavelength reference the distance between the fibre tip and the mirror can be accurately measured.

The received signal will follow the general equations for an interferometer where E₀ is the optical power incident to the probe and λ₁ is the wavelength of the light and part of the light signal is reflection at the fibre tip and another part at the mirror shown in FIG. 2 as Reflection 1 (230) and Reflection 2 (235) respectively. The general equation in this case is shown below:

$${E}_{r} ( t ) = \sqrt{{R}_{1}} {E}_{0} Cos ( \frac{2 π c}{{λ}_{1}} t ) + \sqrt{{R}_{2}} {E}_{0} Cos ( \frac{2 π c}{{λ}_{1}} ( t + τ ) )$$

where

$$τ = \frac{2 d}{c} .$$

R₁ is the magnitude of the reference reflection

R₂ is the magnitude of the measurement reflection. In some applications the magnitude can also include the coupling losses from fibre tip to mirror and back to fibre tip.

d is the distance between the reference reflection and the measurement reflection (i.e. shown as Distance (240) in FIG. 2.)

and

c is the speed of light

Using square law detection on the photodiode the following is obtained for the receiver Vᵣ:

$${V}_{r} ∝ {R}_{1} + {R}_{2} + \sqrt{{R}_{1} {R}_{2}} Cos ( \frac{4 π d}{{λ}_{l}} )$$

As d changes (240), the distance from the fibre tip to the mirror, the received signal will exhibit a periodic oscillation where constructive and destructive interference of the light signal is occurring. This fringe has a period of λ₁/2 where the light signal changes from low intensity to high intensity. Also the Free spectral range of the interferometer is represented by cb2d.

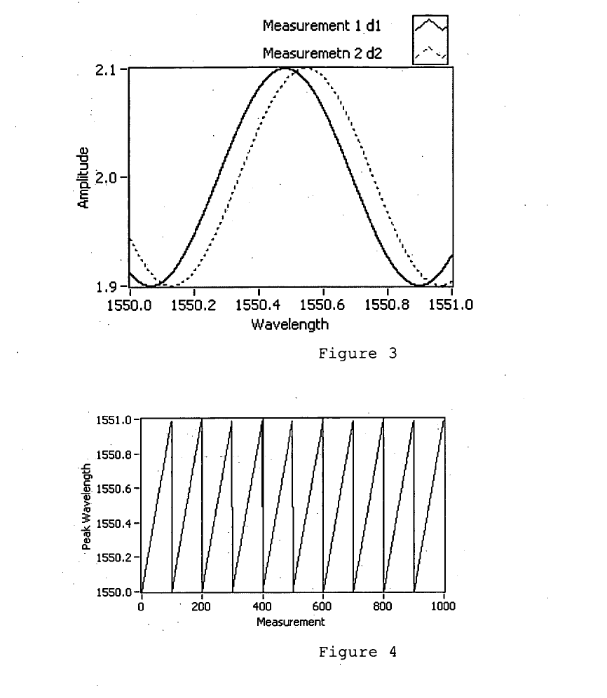

The tunable laser is set-up so that it sweeps wavelength over a predetermined range. This range is such that it covers at least 1 FSR of the interferometer. Hence the optical intensity can be calibrated to the maximum and minimum of the interferometer signal during each measurement, removing a significant error in conventional systems. An example of a measurement is shown in FIG. 3 where the first measurement is for a displacement of d₁ and a second measurement is for a displacement d₂. This error in conventional systems is due to changes in the strength of the interferometer signal, and even with references this can be difficult to normalise as only a single wavelength sample is available. The error is due to using a single wavelength source which interpolates between fringes based on the intensity of the signal remaining fixed, but as d changes, the intensity will also change, and hence add error to the measurement.

The advantage of this method is that the linewidth of the sources contribution to the noise in the measurement can be minimised. By selecting a short optical cavity, e.g. 1 mm, the FSR of the interferometer is approx 1 nm, with a tunable laser the linewidth is typically <10 fm (8 MHz), therefore the noise is <1 part in 100,000. As the laser is configured to scan across a full fringe of the interferometer the noise can be further reduced as multiple samples are taken of the fringe and processed to obtain the peak wavelength. Also as the scan speed for tunable lasers can be set quite high (up to 10's of MHz) the effective linewidth of the laser over the measurement can be reduced further, and the measurement can be performed in a time such that the 1/f noise component of the linewidth can be ignored. In conventional homodyne systems a single wavelength laser is used where the noise from the laser from DC up contributes to the measurement error, which therefore includes the 1/f and lorentzian component of linewidth.

By measuring the peak wavelength on the received signal the phase of the interferometer can be measured. In a typical system where the FSR of the interferometer is 1 nm a measurement of the phase is in terms of wavelength. As the distance between the mirror and the fibre moves the phase the peak wavelength measured will shift correspondingly. When the distance movement is equal to half the wavelength the peak will reset to the start of the wavelength sweep. The dynamic range of the system is such that the distance cannot change by more than 1 quarter of a wavelength between any two measurements and as a peak moves out of range and another is measured a digital counter is updated to preserve the measurement. FIG. 4 shows a series of measurements where the distance is moved linearly over a few micrometers. As can be seen this has a saw-tooth shape as when one peak moves out of range another is measured until it moves out of range.

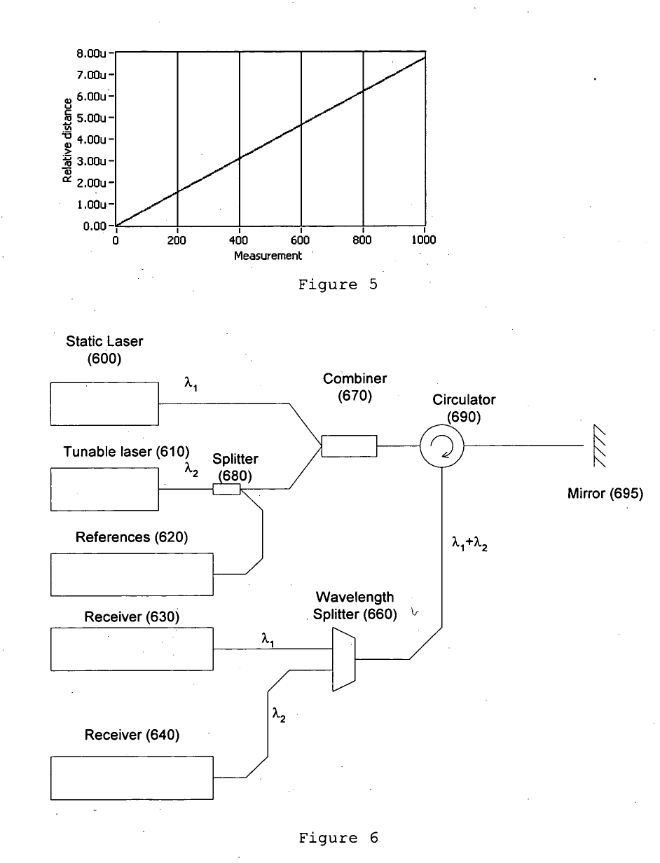

FIG. 5 shows the processed distance measurement when a digital counter is used to count when a peak moves out of range. The counter will increment when it moves out of range on the high wavelength side and decrement when it moves out of range on the low wavelength side.

The laser linewidth will determine the accuracy of the system as this will appear as noise in determination of the wavelength of the fringe. By selecting an FSR of the interferometer this error can be greatly reduced. i.e. as the interferometer path difference d is made short the FSR of the interferometer is broader and hence the wavelength noise in determining a single fringe is reduced. This also means that the wavelength sweep of the laser needs to be increased as d decreases and for a typical system using a distributed Bragg Reflector laser 1 nm is a typical value for the wavelength sweep, hence a interferometer path length difference of approx 1 mm generates an FSR of 1 nm. This means that the laser noise/linewidth, which is typically less than 5 MHz is a small contribution to the noise in the system, i.e. 5 MHz/125 GHz gives a relative noise contribution of 4E-5. Other factors can also reduce the laser noise such as performing measurement very quickly to remove 1/f noise from measurement, a significant problem with single frequency lasers. Over sampling over the wavelength sweep and averaging further reduces the effective laser noise over the measurement interval.

FIG. 2 shows the fibre tip and mirror. The fibre tip is a cleaved fibre end which will have a back reflection of approx 4% which is a reference light beam. The mirror will reflect a portion of the remaining light back into the fibre, which is the measurement light beam. The amount of light returning into the fibre for the measurement beam will depend on the surface roughness of the mirror. In the case where the surface roughness is very small, close to ideal, the light coupled back can be calculated from the divergence angle of light emerging from the fibre tip. For example the divergence angle is φ, the fibre core diameter is r_{f}, the distance between the fibre and mirror is d the relationship between incident power Pᵢ (power leaving the fibre and incident on the mirror) and reflected power back into the fibre Pᵣ is:

$${P}_{r} = {P}_{i} \frac{{r}_{f}^{2}}{4 {d}^{2} {tan}^{2} ( \frac{ϕ}{2} )}$$

where a uniform intensity is assumed over the divergence angle. For a typical value of r_{f}=9 um, d=2 mm, φ=20 degrees 0.65% of the incident light is reflected back into the fibre. In a more detailed study where the distribution of the incident light is considered over the divergence angle the received signal will be higher.

As the losses between the incident light and the received light are quite high this system will not act as a Fabry Perot cavity, but a Mach Zender interferometer. The use of collimating and focusing optics is required to achieve multiple passes through the system.

The spot size of the illumination on the mirror is quite large compared to the effective spot size of the light coupled back into the cavity. The diameter of the effective spot size is less than the diameter of the fibre core. Other configurations can be used which will increase or decrease the spot size through the use of focusing or collimating optics.

It should also be noted that with this optical configuration alignment tolerances to minimise Cosine and Abbé errors are quite low. This is due to light rays that are perpendicular to the mirror being coupled back into the fibre and alignment is only required to ensure reasonable coupling efficiency.

In a typical configuration the distance between the fibre tip and measurement surface is 1 mm, the tunable, laser is configured to scan >1 nm at 1550 nm and at rates >10 kHz, a gas cell is used as an optical reference and the wavelength of the fringe of the interferometer can be determined to better than 200 fm. This provides an accuracy of:

$$Accuracy = \frac{FringeAccuracy}{FreeSpectralRange} \frac{laser\_wavelength}{2}$$

Which in the example above gives an accuracy of approximately 0.15 nm.

In another embodiment of this invention a separate optical path can be used for the reference beam and the fibre tip can be anti-reflection coated. Then the reflected signal from the mirror and the reference beam can be coupled back together either with bulk optics or a fibre coupler. This means that a short optical cavity can be achieved by matching the path lengths while also having a larger distance between the fibre and mirror. This allows more space between the mirror and fibre for collimating and focusing optics but at the price of a more complicated system as effects such as polarisation will have to be monitored carefully to avoid fading of the interferometer signal.

In a further embodiment, shown in FIG. 6, another laser is used at a wavelength different (600) to the tunable laser (610). This laser output is combined with the tunable laser output in a combiner (670) such as a coupler and passed through the same optical system as the tunable laser. The outputs of the two lasers are then separated again in a wavelength splitter (660) so the responses of the interferometer from both signals can be measured independently. This static laser wavelength is used to count fringes and can be used to increment or decrement the digital counter mentioned previously. This is enabled by measuring when a fringe passes over the static wavelength. By the use of some wavelength modulation of this laser the direction of movement of a fringe can be measured and the order of the fringe measured by the scanning laser can be maintained. The direction can be measured by decoding the modulation in either an in-phase or out of phase quadrature modulation component on the receiver. i.e. if a fringe moves down in wavelength and is tracked by the static laser, the counter can be decremented.

Referencing of the wavelength scan can be obtained from a gas cell, Fabry Perot cavity, fibre Bragg grating or some other optical artefact can be used.

The tunable laser can also be used to scan more than one FSR of the interferometer, e.g. the laser could scan over 40 nm, while the FSR of the interferometer could be 1 nm, hence 40 periods of the interferometer wavelength response can be monitored. Each peak/fringe can then be measured and an average value obtained over the 40 peaks, providing an increase in accuracy. The exact ratio of FSR of the interferometer and wavelength scan range can be optimised for different requirements, such as accuracy, measurement time and minimisation of noise from the linewidth of the laser.

It will be appreciated that the terms ‘wavelength scan’ and ‘wavelength sweep’ in the context of understanding the present invention should be used interchangeably and be afforded the widest possible interpretation.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

The invention is not limited to the embodiments hereinbefore described but may be varied in both construction and detail.

The words “comprises/comprising” and the words “having/including” when used herein with reference to the present invention are used to specify the presence of stated features, integers, steps or components but does not preclude the presence or addition of one or more other features, integers, steps, components or groups thereof.

1. A displacement measuring interferometer system for measuring the distance between two known points comprising:
a. an interferometer configured to provide a reference reflection of a reference point and a measurement reflection of a measurement point; and
b. a tunable laser configured to scan in wavelength into the interferometer to detect interferometer characteristics to measure the distance between said reference point and said measurement point from said interferometer characteristics.

2. The system as claimed in claim 1 wherein the interferometer is configured by means of a fibre tip and wherein said reference reflection is obtained from a glass to air interface at the tip of said fibre and said measurement reflection is obtained from a reflection of the transmitted light from the fibre tip to the measurement point and back to the fibre tip.

3. The system as claimed in claim 1 wherein the tunable laser is configured to scan over a wavelength range of at least one fringe of the interferometer.

4. The system as claimed in claim 1 wherein said reference point, such as a gas cell, fibre Bragg grating or Fabry Perot etalon, is used to reference the wavelength scan of the tunable laser.

5. The system as claimed in claim 3 wherein the wavelength of a fringe of the interferometer is determined from a time and wavelength measurement of the tunable laser.

6. The system as claimed in claim 1 wherein the tunable laser is configured to scan over a wavelength range of at least one fringe of the interferometer and wherein a digital counter is used to increment or decrement when a fringe moves out of range of the wavelength range of the tunable laser and another one is measured.

7. The system as claimed in claim 3 wherein an additional tunable laser is used to monitor a fringe and increment or decrement the digital counter.

8. The system as claimed in claim 3 wherein the wavelength of a fringe of the interferometer is determined from a time and wavelength measurement of the tunable laser and said measured wavelength of a fringe is used to calculate the distance between the fibre tip and the measurement point.

9. The system as claimed in claim 3 wherein the wavelength of a fringe of the interferometer is determined from a time and wavelength measurement of the tunable laser and said measured wavelength of a fringe is used to calculate the distance between the fibre tip and the measurement point and wherein the tunable laser performs the wavelength measurement at high sample rates.

10. The system as claimed in claim 1 wherein averaging and/or filtering is performed on data to improve the accuracy of the system.

11. The system as claimed in claim 2 wherein the fibre tip is anti-reflection coated and a second optical path is used to provide a reference beam.

12. A method of measuring the distance between two known points in a displacement measuring interferometer system comprising the steps of:
configuring an interferometer to provide a reference reflection of a reference point and a measurement reflection of a measurement point;
scanning in wavelength into the interferometer from a tunable laser to detect interferometer characteristics; and
measuring the distance between said reference point and said measurement point from said interferometer characteristics.

13. A computer program comprising program instructions for causing a computer to perform the method of claim 12.
